(19) United States
(12) Patent Application Publication
(10) Pub. No.: US 2022/0177701 A1
(43) Pub. Date: Jun. 9, 2022

(54) POLYAMIDE MOLDING COMPOUNDS HAVING INCREASED HYDROLYSIS RESISTANCE

(71) Applicant: BASF SE, Ludwigshafen am Rhein (DE)

(72) Inventors: Jens Cremer, Ludwigshafen (DE); Rainer Xalter, Ludwigshafen (DE)

(21) Appl. No.: 17/433,374

(22) PCT Filed: Feb. 24, 2020
(86) PCT No.: PCT/EP2020/054754

§ 371 Date: Aug. 24, 2021

(30) Foreign Application Priority Data
Feb. 25, 2019 (EP) 19159212.0

(51) Int. Cl. C08L 77/06

(52) U.S. Cl. CPC C08L 77/06; C08L 2205/025

(57) ABSTRACT

Described herein is a thermoplastic molding material including
a) a mixture of 100 parts by weight of polyamide 6 or polyamide 6/6,6 and 5 to 100 parts by weight of aliphatic polyamide composed of C4-10-diamine and C₈₋₁₆-dicarboxylic acid as component A),
b) 10 to 70% by weight, based on component A), of glass fibers as component B), and
c) 0 to 30% by weight, based on component A), of further additives as component C),
   preferably with a reduction in breaking stress according to ISO 527 after storage for 3000 h at 120° C. in a monoethylene glycol/water mixture in a 1:1 weight ratio of not more than 78%.

The invention relates to polyamide molding materials having improved hydrolysis resistance towards water or aqueous liquids, such as coolant mixtures. The molding materials should be suitable for the production of components in particular in the automotive sector.

Polyamides are among the polymers produced on a large scale globally and, in addition to their main fields of use in films, fibers and shaped articles (materials), serve a multitude of other end uses. Among the polyamides, polyamide 6 (polycaprolactam) and polyamide 66 (Nylon, polyhexamethyleneadipamide) are the polymers produced in the largest volumes. Most polyamides of industrial significance are semicrystalline or amorphous thermoplastic polymers featuring a high thermal stability. Hydrolysis resistance may be improved through the use of blends.

EP 2 562 219 A1 relates to thermoplastic molding materials having elevated hydrolysis resistance which comprise not only polyamides but also copolymers of at least one olefin and at least one acrylic ester of an aliphatic alcohol as well as fillers and reinforcers and oligomeric or polymeric carbodiimide. Polyamide 6 and polyamide 66 are recited as particularly preferred.

EP 2 057 223 B1 relates to polyamide molding materials having improved heat aging and hydrolysis resistance. The molding materials comprise at least one polyamide comprising a number of amino end groups of at least 50 mmol/kg, glass fibers and a heat stabilizer. The polyamide preferably has a viscosity number of 100 to 250 ml/g. The polyamide is preferably selected from polyamide 66 and mixtures of polyamides having a polyamide 66 proportion of at least 80% by weight or corresponding copolyamides.

EP 2 831 159 B1 relates to thermoplastic molding materials having elevated hydrolysis resistance which comprise not only polyamides having a number of amino end groups of at least 50 mmol/kg but also fillers and reinforcers, copper iodide/potassium bromide mixtures and montan wax.

EP 0 129 974 A2 relates to polyamide articles which are resistant to antifreeze agents. The reinforced compositions comprise polyamide 66, polyamide 6 or polyamide 6,10 and a copolymer based on ethylenically unsaturated monomers having functional groups.

JP 2004/003056 relates to a polyamide 66 resin with a polyamide 6,10 resin for producing highly stretchable polyamide fibers. The resin may also comprise polyamide 6.

JP 2002339164 relates to highly stretchable polyamide fibers comprising a mixture of polyamide 6,10 and polyamide 6.

JPS57212252 relates to mixtures of polyamide 6 with 5% to 35% by weight of polyamide 6,10 which are said to exhibit improved resistance to calcium chloride.

The present invention has for its object to provide thermoplastic molding materials which are especially suitable for producing components in the automotive sector having improved hydrolysis resistance towards water or aqueous liquids, such as coolant mixtures.

The object is achieved according to the invention by a thermoplastic molding material comprising
a) a mixture of 100 parts by weight of polyamide 6 or polyamide 6/6,6 and 5 to 100 parts by weight of aliphatic polyamide composed of C₄₋₁₀-diamine and C₈₋₁₆-dicarboxylic acid as component A),
b) 10 to 70% by weight, based on component A), of glass fibers as component B),
c) 0 to 30% by weight, based on component A), of further additives as component C),

preferably with a reduction in breaking stress according to ISO 527 after storage for 3000 h at 120° C. in a monoethylene glycol/water mixture in a 1:1 weight ratio of not more than 78%, particularly preferably not more than 75%, in particular not more than 70%.

The object is further achieved by a process for producing such molding materials wherein the components A) and B) and optionally C) are mixed with one another.

The object is further achieved by the use of the molding materials for producing fibers, films or shaped articles and by corresponding fibers, films or shaped articles, preferably shaped articles.

The object is further achieved by the use of mixtures of 100 parts by weight of polyamide 6 or polyamide 6/6,6 and 5 to 100 parts by weight of aliphatic polyamide composed of C₄₋₁₀-diamine and C₈₋₁₆-dicarboxylic acid in molding materials for producing shaped articles having elevated hydrolysis resistance of molding materials towards water or aqueous liquids, such as monoethylene glycol/water mixtures, for example coolant mixtures.

The object is further achieved by the use of mixtures of 100 parts by weight of polyamide 6 or polyamide 6/6,6 and 5 to 100 parts by weight of aliphatic polyamide composed of C₄₋₁₀-diamine and C₆₋₁₈-dicarboxylic acid for increasing the hydrolysis resistance of molding materials having elevated hydrolysis resistance of molding materials towards water or aqueous liquids, such as monoethylene glycol/water mixtures, for example coolant mixtures.

The object is further achieved by the use of mixtures of 100 parts by weight of polyamide 6 or polyamide 6,6 and 5 to 100 parts by weight of aliphatic polyamide composed of C₄₋₁₀-diamine and C₆₋₁₈-dicarboxylic acid for increasing the breaking stress of shaped articles comprising such mixtures which are in contact with monoethylene glycol.

Coolant mixtures are used as cooling water additives in internal combustion engines in particular. These are for example monoethylene glycol or mixtures comprising monoethylene glycol as well as additional anticorrosion agents, such as silicates and/or organic acids. In use the monoethylene glycol is mixed with water and the mixing ratio is chosen according to the desired target temperature. For protection against the cold down to −40° C. a volume ratio of antifreeze to water of 50:50 is established. For protection against the cold down to −10° C. a proportion of 20 parts by volume of antifreeze to 80 parts by volume of water is sufficient. A customary antifreeze is marketed by BASF SE under the trade name GLYSANTIN®.

The thermoplastic molding materials comprise as component A) a mixture of 100 parts by weight of polyamide 6 or polyamide 6/6,6 and 5 to 100 parts by weight of aliphatic polyamide composed of C₄₋₁₀-diamine and C₈₋₁₆-dicarboxylic acid.

Polyamide 6 is a homopolymer based on caprolactam or aminocapronitrile.

Polyamide 6/6,6 is a copolyamide comprising any desired proportions of monomers of polyamide 6 and polyamide 6,6 or a mixture of both polyamides. Both components may be employed in identical mole fractions, in excess or deficiency. Mixtures of polyamide 6 and polyamide 6,6 may also be employed. However, it is particularly preferable when in addition to polyamide 6 no copolyamide 6/6,6 or polyamide 6,6 is employed or the proportion of polyamide 6,6 or corresponding monomer units in the overall polyamide 6/6,6 is preferably not more than 50 mol %, particularly preferably not more than 20 mol %, in particular not more than 10 mol %.

Employed according to the invention in particular are polyamide 6 and copolymers or mixtures thereof with polyamide 66. The polyamide 6 preferably has a viscosity number of in the range from 80 to 180 ml/g, in particular 85 to 160 ml/g, in particular 90 to 140 ml/g, determined in a 0.5% by weight solution in 96% by weight sulfuric acid at 25° C. according to ISO 307.

A polyamide 66 suitable for the mixture preferably has a viscosity number in the range from 110 to 170 ml/g, particularly preferably 130 to 160 ml/g, determined in a 0.5% by weight solution in 96% by weight sulfuric acid at 25° C. according to ISO 307.

The aliphatic polyamide composed of C₄₋₁₀-diamine and C₈₋₁₆-dicarboxylic acid is constructed from aliphatic diamines and dicarboxylic acids which are preferably terminal and linear. It is particularly preferable to employ an aliphatic, terminal, linear C₅₋₈-diamine, especially hexamethylenediamine. The dicarboxylic acid is preferably an aliphatic, linear and terminal C₈₋₁₂-dicarboxylic acid, particularly preferably C₉₋₁₁-dicarboxylic acid, especially 1,10-decanedioic acid. Polyamide 6,10, polyamide 6,12 and mixtures thereof are preferred. Polyamide 6,10 is especially preferred.

In the component A) the proportion thereof is preferably 7 to 50 parts by weight, particularly preferably 10 to 70 parts by weight, based on the first polyamide.

As components B) the thermoplastic molding materials comprise 10% to 70% by weight, preferably 20% to 65% by weight, particularly preferably 25% to 60% by weight, especially preferably 40% to 60% by weight, based on component A), of glass fibers.

Especially chopped glass fibers may be employed. The component B) especially comprises glass fibers, it being preferable to employ short fibers. These preferably have a length in the range from 2 to 50 mm and a diameter of 5 to 40 μm. It is alternatively possible to use continuous fibers (rovings). Suitable fibers include those having a circular and/or noncircular cross-sectional area, wherein in the latter case the dimensional ratio of the main cross-sectional axis to the secondary cross-sectional axis is especially >2, preferably in the range from 2 to 8 and particularly preferably in the range from 3 to 5.

In a specific embodiment component B) comprises so-called “flat glass fibers”. These specifically have an oval or elliptical cross-sectional area or a necked elliptical (so-called “cocoon” fibers) or rectangular or virtually rectangular cross-sectional area. Preference is given here to using glass fibers with a noncircular cross-sectional area and a dimensional ratio of the main cross-sectional axis to the secondary cross-sectional axis of more than 2, preferably of 2 to 8, in particular of 3 to 5.

Reinforcement of the molding materials according to the invention may also be effected using mixtures of glass fibers having circular and noncircular cross sections. In a specific embodiment the proportion of flat glass fibers, as defined above, predominates, i.e. they account for more than 50% by weight of the total mass of the fibers.

When rovings of glass fibers are used as component B) said fibers preferably have a diameter of 10 to 20 μm, preferably of 12 to 18 μm. The cross section of these glass fibers may be round, oval, elliptical, virtually rectangular or rectangular. So-called flat glass fibers having a ratio of the cross-sectional axes of 2 to 5 are particularly preferred. E glass fibers are used in particular. However, it is also possible to use any other glass fiber types, for example A, C, D, M, S or R glass fibers, or any desired mixtures thereof or mixtures with E glass fibers.

As component C) the compositions according to the invention may comprise 0% to 30% by weight, preferably 0% to 20% by weight, in particular 0% to 10% by weight, based on component A), of further additives. In the event of co-use of such additives the minimum amount is 0.1% by weight, preferably 0.15% by weight, in particular 1% by weight, based on component A).

The percentages by weight are based on component A).

Contemplated further additives include thermoplastic polymers distinct from component A), fillers and reinforcers distinct from glass fibers of component B) or further additives.

In the below-mentioned additives suitable as component C) the respective percentages by weight relate to component A). If a plurality of additives are present the upper limit recited at the beginning applies to the sum of the amounts of all additives.

Suitable preferred additives C) are lubricants and heat stabilizers but also flame retardants, light stabilizers (UV stabilizers, UV absorbers or UV blockers), dyes, nucleating agents, metallic pigments, metal flakes, metal-coated particles, antistats, conductivity additives, demolding agents, optical brighteners, defoamers, etc.

As component C) the molding materials according to the invention may preferably comprise 0.1% to 5% by weight, particularly preferably 0.2% to 2.5% by weight, in particular 0.5% to 1.5% by weight, of at least one heat stabilizer based on the total weight of the component A).

The heat stabilizers are preferably selected from copper compounds, secondary aromatic amines, sterically hindered phenols, phosphites, phosphonites and mixtures thereof.

If a copper compound is used the amount of copper is preferably 0.003% to 0.5% by weight, in particular 0.005% to 0.3% by weight and particularly preferably 0.01% to 0.2% by weight based on the total weight of the component A).

If stabilizers based on secondary aromatic amines are used the amount of these stabilizers is preferably 0.2% to 2% by weight, particularly preferably 0.2% to 1.5% by weight, based on the total weight of the component A).

If stabilizers based on sterically hindered phenols are used the amount of these stabilizers is preferably 0.1% to 1.5% by weight, particularly preferably 0.2% to 1% by weight, based on the total weight of the component A).

If stabilizers based on phosphites and/or phosphonites are used the amount of these stabilizers is preferably 0.1% to 1.5% by weight, particularly preferably from 0.2% to 1% by weight, based on the total weight of the component A).

Suitable compounds C) of mono- or divalent copper are, for example, salts of mono- or divalent copper with inorganic or organic acids or mono- or dihydric phenols, the oxides of mono- or divalent copper or the complexes of copper salts with ammonia, amines, amides, lactams, cyanides or phosphines, preferably Cu(I) or Cu(II) salts of the hydrohalic acids or of the hydrocyanic acids or the copper salts of the aliphatic carboxylic acids. Particular preference is given to the monovalent copper compounds CuCl, CuBr, CuI, CuCN and Cu₂O and to the divalent copper compounds CuCl₂, CuSO₄, CuO, copper(II) acetate or copper(II) stearate.

The copper compounds are commercially available and/or the production thereof is known to those skilled in the art. The copper compound may be used as such or in the form of concentrates. A concentrate is to be understood as meaning a polymer, preferably of the same chemical nature as component C), comprising the copper salt in a high concentration. The use of concentrates is a customary process and is particularly often employed when very small amounts of an input material are to be added. It is advantageous to employ the copper compounds in combination with further metal halides, in particular alkali metal halides, such as NaI, KI, NaBr, KBr, wherein the molar ratio of metal halide to copper halide is 0.5 to 20, preferably 1 to 10 and particularly preferably 3 to 7.

Particularly preferred examples of stabilizers which are based on secondary aromatic amines and are usable in accordance with the invention include adducts of phenylenediamine with acetone (Naugard® A), adducts of phenylenediamine with linolenic acid, 4,4′-bis(α,α-dimethylbenzyl)diphenylamine (Naugard® 445), N,N′-dinaphthyl-p-phenylenediamine, N-phenyl-N′-cyclohexyl-p-phenylenediamine or mixtures of two or more thereof.

Preferred examples of stabilizers employable according to the invention and based on sterically hindered phenols include N,N′-hexamethylenebis-3-(3,5-di-tert-butyl-4-hydroxyphenyl)propionamide, bis(3,3-bis(4′-hydroxy-3′-tert-butylphenyl)butanoic acid) glycol ester, 2,1′-thioethyl bis(3-(3,5-di-tert-butyl-4-hydroxyphenyl))propionate, 4,4′-butylidenebis(3-methyl-6-tert-butylphenol), triethylene glycol 3-(3-tert-butyl-4-hydroxy-5-methylphenyl)propionate or mixtures of two or more of these stabilizers.

Preferred phosphites and phosphonites are triphenyl phosphite, diphenyl alkyl phosphite, phenyl dialkyl phosphite, tris(nonylphenyl) phosphite, trilauryl phosphite, trioctadecyl phosphite, distearyl pentaerythrityl diphosphite, tris(2,4-di-tert-butylphenyl) phosphite, diisodecyl pentaerythrityl diphosphite, bis(2,4-di-tert-butylphenyl) pentaerythrityl diphosphite, bis(2,6-di-tert-butyl-4-methylphenyl) pentaerythrityl diphosphite, diisodecyloxy pentaerythrityl diphosphite, bis(2,4-di-tert-butyl-6-methylphenyl) pentaerythrityl diphosphite, bis(2,4,6-tris(tert-butylphenyl)) pentaerythrityl diphosphite, tristearylsorbitol triphosphite, tetrakis(2,4-di-tert-butylphenyl)-4,4′-biphenylene diphosphonite, 6-isooctyloxy-2,4,8,10-tetra-tert-butyl-12H-dibenzo-[d,g]-1,3,2-dioxaphosphocin, 6-fluoro-2,4,8,10-tetra-tert-butyl-12-methyldibenzo-[d,g]-1,3,2-dioxaphosphocin, bis(2,4-di-tert-butyl-6-methylphenyl)methyl phosphite and bis(2,4-di-tert-butyl-6-methylphenyl) ethyl phosphite. Preference is given in particular to tris[2-tert-butyl-4-thio(2′-methyl-4′-hydroxy-5′-tert-butyl)phenyl-5-methyl]phenyl phosphite and tris(2,4-di-tert-butylphenyl) phosphite (Hostanox® PAR24: commercially available product from BASF SE).

A preferred embodiment of the heat stabilizer consists in the combination of organic heat stabilizers (especially Hostanox PAR 24 and Irganox 1010), a bisphenol A-based epoxide (especially Epikote 1001) and a copper stabilization based on CuI and KI. An example of a commercially available stabilizer mixture consisting of organic stabilizers and epoxides is Irgate® NC66 from BASF SE. Heat stabilization based exclusively on CuI and KI is especially preferred. Other than the addition of copper or copper compounds, the use of further transition metal compounds, especially metal salts or metal oxides of group VB, VIB, VIIB or VIIIB of the Periodic Table, is possible or alternatively precluded. It may moreover be preferable not to add transition metals of group VB, VIB, VIIB or VIIIB of the Periodic Table, for example iron powder or steel powder, to the molding material according to the invention or not.

As component C) the polyamide compositions according to the invention may comprise nigrosin, preferably in an amount of 0.05% to 1% by weight, particularly preferably 0.1% to 0.5% by weight, in particular 0.2% to 0.4% by weight, based on component A).

Nigrosin (Solvent Black 7—CAS: 8005-02-5) is a deep-black organic dye.

Nigrosin is a mixture of synthetic black colorants and is obtained by heating nitrobenzene, aniline and aniline hydrochloride in the presence of an iron or copper catalyst. Nigrosins occur in various forms (water-soluble, alcohol-soluble and oil-soluble). A typical water-soluble nigrosin is Acid Black 2 (C.I. 50420), a typical alcohol soluble nigrosin is Solvent Black 5 (C.I. 50415), and a typical oil-soluble nigrosin is Solvent Black 7 (C.I. 50415:1).

However, nigrosin is not entirely unconcerning in terms of a possible damaging effect on health. For example residues of aniline and nitrobenzene may remain in the product as a consequence of production and there is a risk of unwanted decomposition products being formed in the course of subsequent processing by extrusion methods, injection molding methods or spinning methods.

The addition of nigrosin to the polyamide compositions according to the invention can further reduce the crystallization tendency of the polyamide composition since nigrosin disrupts crystallization. The addition thus results in a slower crystallization/reduction in the crystallization temperature.

It may additionally be advantageous to use Solvent Black 28 (CAS No. 12237-23-91) and to optionally combine it with at least one further colorant. The component C) is then preferably selected from non-nucleating colorants distinct from nigrosin. These include non-nucleating dyes, non-nucleating pigments and mixtures thereof. Examples of non-nucleating dyes are Solvent Yellow 21 (commercially available as Oracet® Yellow 160 FA from BASF SE) or Solvent Blue 104 (commercially available as Solvaperm® Blue 2B from Clariant). Examples of non-nucleating pigments are Pigment Brown 24 (commercially available as Sicotan® Yellow K 2011 FG from BASF SE). Also suitable as component B) are small amounts of at least one white pigment. Suitable white pigments are titanium dioxide (Pigment White 6), barium sulfate (Pigment White 22), zinc sulfide (Pigment White 7) etc. In a specific embodiment the molding material according to the invention comprises 0.001% to 0.5% by weight of at least one white pigment as component E). For example, the molding material may comprise 0.05% by weight of Kronos 2220 titanium dioxide from Kronos.

The manner and amount of the addition is guided by the hue, i.e. the desired shade of the black color. For example, with Solvent Yellow 21, it is possible to move the hue of the black color in the CIELAB color space from, for example, b*=−1.0 in the direction of +b*, i.e. in the yellow direction. This method is known to those skilled in the art as color shading. Measurement is effected in accordance with DIN 6174 “Colorimetric evaluation of colour coordinates and colour differences according to the approximately uniform CIELAB colour space” or the successor standard.

Co-use of carbon black as component C) is also possible. The compositions according to the invention comprise for example 0.05% to 3% by weight, by preference 0.07% to 1% by weight, preferably 0.1% to 0.2% by weight, of carbon black. Carbon black, also known as industrial carbon black, is a modification of carbon with a high surface-to-volume ratio and consists of 80% to 99.5% by weight of carbon. The specific surface area of industrial carbon black is about 10 to 1500 m²/g (BET). The carbon black may be produced in the form of channel black, furnace black, flame black, cracking black or acetylene black. The particle diameters are in the range from 8 to 500 nm, typically 8 to 110 nm. Carbon black is also referred to as pigment black 7 or lamp black 6. Color blacks are nanoparticulate carbon blacks that, due to their fineness, increasingly lose the brown base hue of conventional carbon blacks.

As component C) or a portion thereof the thermoplastic molding materials may comprise 0% to 25% by weight, by preference 0% to 15% by weight, preferably 0% to 10% by weight, in particular 0% to 5% by weight, of at least one thermoplastic polyamide distinct from polyamides of the component A). However, it is preferable when no further polyamides are present.

These polyamides generally have a viscosity number of 90 to 210 ml/g, preferably 110 to 160 ml/g, determined in a 0.5% by weight solution in 96.0% by weight sulfuric acid at 25° C. according to ISO 307.

Semicrystalline or amorphous resins having a molecular weight (weight average) of at least 5000, such as are described for example in U.S. Pat. Nos. 2,071,250, 2,071,251, 2,130,523, 2,130,948, 2,241,322, 2,312,966, 2,512,606 and 3,393,210, are preferred.

Examples thereof are polyamides which derive from lactams having 8 to 13 ring members, such as polycaprylolactam and polylaurolactam, and also polyamides obtained by reaction of dicarboxylic acids with diamines.

Employable dicarboxylic acids include alkanedicarboxylic acids having 6 to 12 carbon atoms, in particular 6 to 10 carbon atoms, and aromatic dicarboxylic acids. These only include the acids adipic acid, azelaic acid, sebacic acid, dodecanedioic acid and terephthalic and/or isophthalic acid.

Particularly suitable diamines include alkanediamines having 6 to 12, in particular 6 to 9, carbon atoms and m-xylylenediamine, di(4-aminophenyl)methane, di(4-aminocyclohexyl)methane, 2,2-di(4-aminophenyl)propane, 2,2-di(4-aminocyclohexyl)propane or 1,5-diamino-2-methylpentane.

Also suitable are polyamides obtainable for example by condensation of 1,4-diaminobutane with adipic acid at elevated temperature (polyamide 4,6). Production processes for polyamides having this structure are described for example in EP-A-38 094, EP-A-38 582 and EPA-039 524.

Also suitable are polyamides obtainable by copolymerization of two or more of the abovementioned monomers or mixtures of a plurality of polyamides in any desired mixing ratio.

Suitable polyamides preferably have a melting point of less than 265° C.

The following nonexhaustive list includes the recited polyamides and also further polyamides within the meaning of the invention (including component A)) as well as the monomers present.

AB Polymers:

| | |
|---|---|
| PA 4 | pyrrolidone |
| PA 6 | ε -caprolactam |
| PA 7 | ethanolactam |
| PA 8 | caprylolactam |
| PA 9 | 9-aminopelargonic acid |
| PA 11 | 11-aminoundecanoic acid |
| PA 12 | laurolactam |

AA/BB Polymers:

| | |
|---|---|
| PA 46 | tetramethylenediamine, adipic acid |
| PA 66 | hexamethylenediamine, adipic acid |
| PA 69 | hexamethylenediamine, azelaic acid |
| PA 610 | hexamethylenediamine, sebacic acid |
| PA 612 | hexamethylenediamine, decanedicarboxylic acid |
| PA 613 | hexamethylenediamine, undecanedicarboxylic acid |
| PA 1212 | 1,12-dodecanediamine, decanedicarboxylic acid |
| PA 1313 | 1,13-diaminotridecane, undecanedicarboxylic acid |
| PA 6T | hexamethylenediamine, terephthalic acid |
| PA MXD6 | m-xylylenediamine, adipic acid |
| PA 9T | nonamethylenediamine, terephthalic acid |

AA/BB Polymers:

| | |
|---|---|
| PA6I | hexamethylenediamine, isophthalic acid |
| PA 6-3-T | trimethylhexamethylenediamine, terephthalic acid |
| PA 6/6T | (see PA 6 and PA 6T) |
| PA 6/66 | (see PA 6 and PA 66) |
| PA 6/12 | (see PA 6 and PA 12) |
| PA 66/6/610 | (see PA 66, PA 6 and PA 610) |
| PA 6I/6T | (see PA 6I and PA 6T) |
| PAPACM 12 | diaminodicyclohexylmethane, laurolactam |
| PA 6I/6T/ | as per PA 6I/6T + diaminodicyclohexylmethane, |
| PACMT | terephthalic acid |
| PA 6T/6I/ | as per PA 6I/6T + dimethyldiaminocyclohexylmethane, |
| MACMT | terephthalic acid |
| PA 6T/6I/MXDT | as per PA 6I/6T + m-xylylenediamine, terephthalic acid |
| PA 12/MACMI | laurolactam, dimethyldiaminodicyclohexylmethane, |
| | isophthalic acid |
| PA 12/MACMT | laurolactam, dimethyldiaminodicyclohexylmethane, |
| | terephthalic acid |
| PA PDA-T | phenylenediamine, terephthalic acid |
| PA 6T/6I | (see PA 6T and PA 6I) |
| PA 6T/66 | (see PA 6T and PA 66) |

Component C) may be a blend of at least one aliphatic polyamide and at least one semiaromatic or aromatic polyamide.

According to the invention mixtures comprising polyamide 61/61 for example are employed as component C.

In place of or in addition to polyamide 61/61 it is also possible to employ polyamide 61 or polyamide 6T or mixtures thereof.

Also possible for example is co-use of a copolyamide produced by polymerization of the components
A′) 15% to 84% by weight of at least one lactam,
B′) 16% to 85% by weight of a monomer mixture (M) comprising the components
   B1′) at least one C₃₂-C₄₃-dimer acid and
   B2′) at least one C₄-C₁₂-diamine,

wherein the percentages by weight of the components A′) and B′) are in each case based on the sum of the percentages by weight of the components A′) and B′).

Particularly preferred as such a component is PA6/6,36.

Co-use of further polymers in addition to the abovementioned polyamide/component A) is also possible. However, this is less preferred.

The thermoplastic polymers distinct from component A) are preferably selected from
homo- or copolymers which comprise in copolymerized form at least one monomer selected from C₂-C₁₀-monoolefins, for example ethylene or propylene, 1,3-butadiene, 2-chloro-1,3-butadiene, vinyl alcohol and the C₂-C₁₀-alkyl esters thereof, vinyl chloride, vinylidene chloride, vinylidene fluoride, tetrafluoroethylene, glycidyl acrylate, glycidyl methacrylate, acrylates and methacrylates having alcohol components of branched and unbranched C₁-C₁₀-alcohols, vinylaromatics, for example styrene, acrylonitrile, methacrylonitrile, α/β-ethylenically unsaturated mono- and dicarboxylic acids, and maleic anhydride,
homo- and copolymers of vinyl acetals,
polyvinyl esters,
polycarbonates (PC),
polyesters, such as polyalkylene terephthalates, polyhydroxyalkanoates (PHA), polybutylene succinates (PBS), polybutylene succinate adipates (PBSA),
polyethers,
polyether ketones,
thermoplastic polyurethanes (TPU),
polysulfides,
polysulfones,
polyether sulfones,
cellulose alkyl esters

and mixtures thereof.

Examples include polyacrylates having identical or different alcohol radicals from the group of C₄-C₈ alcohols, particularly of butanol, hexanol, octanol and 2-ethylhexanol, polymethylmethacrylate (PMMA), methyl methacrylate-butyl acrylate copolymers, acrylonitrile-butadiene-styrene copolymers (ABS), ethylene-propylene copolymers, ethylene-propylene-diene copolymers (EPDM), polystyrene (PS), styrene-acrylonitrile copolymers (SAN), acrylonitrilestyrene-acrylate (ASA), styrene-butadiene-methyl methacrylate copolymers (SBMMA), styrene-maleic anhydride copolymers, styrene-methacrylic acid copolymers (SMA), polyoxymethylene (POM), polyvinyl alcohol (PVAL), polyvinyl acetate (PVA), polyvinyl butyral (PVB), polycaprolactone (PCL), polyhydroxybutyric acid (PHB), polyhydroxyvaleric acid (PHV), polylactic acid (PLA), ethyl cellulose (EC), cellulose acetate (CA), cellulose propionate (CP) or cellulose acetate/butyrate (CAB).

The at least one thermoplastic polymer present in the molding material according to the invention is preferably polyvinyl chloride (PVC), polyvinyl butyral (PVB), homo- and copolymers of vinyl acetate, homo- and copolymers of styrene, polyacrylates, thermoplastic polyurethanes (TPUs) or polysulfides.

Further fillers and reinforcers may also be used in addition to the glass fibers (component B)).

In the context of the invention the term “filler and reinforcer” (=possible component C)) is to be interpreted broadly and comprises particulate fillers, fibrous substances and any intermediate forms. Particulate fillers may have a wide range of particle sizes ranging from particles in the form of dusts to large grains. Contemplated filler materials include organic or inorganic fillers and reinforcers. Employable here are for example inorganic fillers, such as kaolin, chalk, wollastonite, talc, calcium carbonate, silicates, titanium dioxide, zinc oxide, graphite, glass particles, for example glass spheres, nanoscale fillers, such as carbon nanotubes, nanoscale sheet silicates, nanoscale alumina (Al₂O₃), nanoscale titanium dioxide (TiO₂), graphene, permanently magnetic or magnetizable metal compounds and/or alloys, phyllosilicates and nanoscale silicon dioxide (SiO₂). The fillers may also have been surface treated.

Examples of phyllosilicates usable in the molding materials according to the invention include kaolins, serpentines, talc, mica, vermiculites, illites, smectites, montmorillonite, hectorite, double hydroxides or mixtures thereof. The phyllosilicates may have been surface treated or may be untreated.

One or more additional fibrous substances may—less preferably—also be employed. These are preferably selected from known inorganic reinforcing fibers, such as boron fibers, carbon fibers, silica fibers, ceramic fibers and basalt fibers; organic reinforcing fibers, such as aramid fibers, polyester fibers, nylon fibers, polyethylene fibers and natural fibers, such as wood fibers, flax fibers, hemp fibers and sisal fibers.

The component C) may comprise 0.1 to 1% by weight, preferably 0.1 to 0.5% by weight, of lubricants.

The molding materials according to the invention may comprise as additive B) 0% to 25% by weight, particularly preferably 0% to 15% by weight, based on the weight of the component A), of at least one flame retardant. When the molding materials according to the invention comprise at least one flame retardant, they preferably do so in an amount of 0.01% to 25% by weight, more preferably of 0.1% to 15% by weight, based on the weight of the component A). Suitable flame retardants include halogen-containing and halogen-free flame retardants and synergists thereof (see also Gächter/Müller, 3rd edition 1989 Hanser Verlag, chapter 11). Preferred halogen-free flame retardants are red phosphorus, phosphinic or diphosphinic salts and/or nitrogen-containing flame retardants such as melamine, melamine cyanurate, melamine sulfate, melamine borate, melamine oxalate, melamine phosphate (primary, secondary) or secondary melamine pyrophosphate, neopentyl glycol boric acid melamine, guanidine and derivatives thereof known to those skilled in the art, and also polymeric melamine phosphate (CAS No.: 56386-64-2 and 218768-84-4 and also EP-A-1 095 030), ammonium polyphosphate, trishydroxyethyl isocyanurate (optionally also ammonium polyphosphate in admixture with trishydroxyethyl isocyanurate) (EP-A-058 456 7). Further N-containing or P-containing flame retardants or PN condensates suitable as flame retardants, as well as the synergists customary therefor such as oxides or borates, may be found in DE-A-10 2004 049 342. Suitable halogenated flame retardants are for example oligomeric brominated polycarbonates (BC 52 Great Lakes) or polypentabromobenzyl acrylates with N greater than 4 (FR 1025 Dead sea bromine), reaction products of tetrabromobisphenol A with epoxides, brominated oligomeric or polymeric styrenes, dechlorane, which are usually used with antimony oxides as synergists (for details and further flame retardants see DE-A10 2004 050 025).

Employable as component C) in addition to carbon black and nigrosin is at least one additional colorant selected from anthraquinone colorants, benzimidazolone colorants and perinone colorants. The colorants are preferably dyes, pigments or mixtures thereof.

According to the invention the colorant is employed in an amount of 10 to 1000 ppm, preferably 20 to 500 ppm, in particular 50 to 200 ppm, based on the total molding material.

Preferably employed as component C) are nigrosin, carbon black, lubricants and heat and optionally UV stabilizers. Flame retardant additives are preferably not employed. The co-use of mineral fillers is possible but not preferred. The co-use of further polymers in addition to component A) is also less preferred.

The polyamide molding materials are produced by processes known per se. These include the mixing of the components in the appropriate proportions by weight.

It is also possible to employ recyclates of the individual components or else of mixtures.

The mixing of the components is preferably accomplished at elevated temperatures by commixing, blending, kneading, extruding or rolling. The temperature during mixing is preferably in a range from 220° C. to 340° C., particularly preferably from 240° C. to 320° C. and especially from 250° C. to 300° C. Suitable methods are known to those skilled in the art.

Shaped Articles

The present invention further relates to shaped articles produced using the polyamide molding materials according to the invention.

The polyamide molding materials may be used for producing moldings by any desired suitable processing techniques. Suitable processing techniques are especially injection molding, extrusion, coextrusion, thermoforming or any other known polymer shaping method. These and further examples may be found for example in “Einfärben von Kunststoffen” [Coloring of Plastics], VDI-Verlag, ISBN 3-18-404014-3.

The polyamide molding materials are further advantageously suitable for use for automotive applications, for production of moldings for electrical and electronic components including especially in the high-temperature sector.

A specific embodiment is that of shaped articles in the form of or as part of a component part for the automotive sector, especially selected from cylinder head covers, engine covers, housings for charge air coolers, charge air cooler valves, intake pipes, intake manifolds, connectors, gears, fan impellers, cooling water tanks, housings or housing parts for heat exchangers, coolant coolers, charge air coolers, thermostats, water pumps, heating elements, securing parts.

Automotive interior uses include uses for instrument panels, steering column switches, seat parts, headrests, center consoles, transmission components and door modules and automotive exterior uses include A, B, C or D pillar covers, spoilers, door handles, exterior mirror components, windshield wiper components, windshield wiper housings, decorative grilles, cover strips, roof railings, window frames, sunroof frames, aerial trims, front and rear lights, engine covers, cylinder head covers, intake pipes, windshield wipers and exterior bodywork parts.

A further specific embodiment is that of shaped bodies as such or as part of an electrical or electronic passive or active component, of a printed circuit board, of part of a printed circuit board, of a housing constituent, of a film, or of a wire, more particularly in the form of or as part of a switch, of a plug, of a bushing, of a distributor, of a relay, of a resistor, of a capacitor, of a winding or of a winding body, of a lamp, of a diode, of an LED, of a transistor, of a connector, of a regulator, of an integrated circuit (IC), of a processor, of a controller, of a memory element and/or of a sensor.

The polyamide molding materials according to the invention are moreover especially suitable for producing plug connectors, microswitches, microbuttons and semiconductor components, especially reflector housings of light-emitting diodes (LEDs).

A specific embodiment is that of shaped articles as securing elements for electrical or electronic components, such as spacers, bolts, fillets, push-in guides, screws and nuts.

Especially preferred is a molding in the form of or as part of a socket, of a plug connector, of a plug or of a bushing. The molding preferably includes functional elements which require mechanical toughness. Examples of such functional elements are film hinges, snap-in hooks and spring tongues.

Possible uses of the polyamides according to the invention for the kitchen and household sector are for producing door handles or components for kitchen machines, for example of fryers, clothes irons, and also applications in the gardens sector, for example components for irrigation systems or garden equipment.

The thermoplastic molding materials according to the invention are further suitable as an adhesive layer for metals. They may accordingly be used for coating sheet metals. In this regard reference may also be made to WO 2005/014278.

The polyamide molding material for producing moldings is produced by methods known per se. Reference is made here to the abovementioned processes for producing the polyamide composition. These include the mixing of the components in the appropriate proportions by weight. The mixing of the components is preferably accomplished at elevated temperatures by commixing, blending, kneading, extruding or rolling. The temperature during mixing is preferably in a range from 220° C. to 340° C., particularly preferably from 240° C. to 320° C. and especially from 250° C. to 300° C. Premixing of individual components may be advantageous. It is further also possible to produce the moldings directly from a physical mixture (dryblend) of premixed components and/or individual components which has been produced well below the melting point of the polyamide. In that case the temperature during the mixing is preferably 0° C. to 100° C., particularly preferably 10° C. to 50° C., in particular ambient temperature (25° C.). The molding materials may be processed into moldings by customary processes, for example by injection molding or extrusion. They are especially suitable, for example, for materials for covers, housings, accessory parts, sensors, for applications in, for example, the automotive, electrical engineering, electronics, telecommunications, information technology, computer, household, sports, medical, or entertainment sectors.

The invention is more particularly elucidated hereinbelow by the following examples. All examples relate to black-colored compounds, which are exemplary for all further possible colors. Black is the most critical shade, especially in terms of hydrolysis resistance, since surface changes are most clearly recognizable in black shaped articles.

### EXAMPLES

Materials:
PA 6: Polyamide 6 having a viscosity number VN of 195 ml/g, measured as a 0.5% by weight solution in 96% by weight sulfuric acid at 25° C. according to ISO 307 (Ultramid® from BASF SE).
PA 6,10: Polyamide 6,10 having a viscosity number VN of 150 ml/g, measured as a 0.5% by weight solution in 96% by weight sulfuric acid at 25° C. according to ISO 307 (Zyter RS LC3060 NC010 from DuPont de Nemours (Deutschland) GmbH was used)
Carbon black: Black Pearls® 880 from Cabot
Lubricant: EBS (ethylene-bis-stearamide from Lonza Cologne GmbH)
Nigrosin: Nigrosin (manufacturer: COLLOIDS LTD.) 40% in polyamide 6 (Nigrosin batch)
Heat stabilizer: Naugard® 445 from Addivant Sales Germany GmbH
Glass fibers: ECR glass (chopped glass fiber DS 1110 having average diameter of 10 μm from 3B-FIBREGLASS S.P.R.L.)
Sodium hypophosphite: Monohydrate from Innochem GmbH
Glysantin® G48®: Monoethylene glycol, coolant from BASF SE

Characterization Methods:

Impact strength according to ISO 179-2/1eU (2019 version)

Notched impact strength according to ISO 179-2/1eAf (2019 version)

Tensile elastic modulus according to ISO 527 (2019 version)

Breaking stress according to ISO 527 (2019 version)

Breaking elongation according to ISO 527 (2019 version)

Production of the Compounds:

### Comparison 1, Examples 1 to 2

The plastic molding materials described in the comparative examples and the inventive examples were produced by melt mixing of the individual components in a ZSK 26 MC twin-screw extruder from Coperion at a throughput of 25 kg/h and a housing temperature of 260° C. The melt was discharged as a strand through a 4 mm die, cooled in a water bath until pelletizable and pelletized.

Production of the Test Specimen:

Test specimens were produced on an Arburg 420C injection molding machine according to ISO 179-2/1 for testing of impact strength and notched impact strength and according to ISO 527 for tensile tests.

Hydrolysis Storage:

The test specimens for impact strength, notched impact strength and for tensile tests were stored in the absence of air in an autoclave in a mixture of water and Glysantin® G48® having a mixing ratio of 50:50 at 120° C. with constant stirring. The respective test specimens were removed from the autoclave after the specified storage times and tested immediately afterwards without re-drying according to the ISO standards.

The results are summarized in tables 1 to 3.

TABLE 1

| Composition | Comparison 1 | Example 1 | Example 2 |
|---|---|---|---|
| PA 6 | 63.56 | 57.26 | 50.96 |
| PA 6,10 | 0 | 6.3 | 12.6 |
| Glass fiber | 35 | 35 | 35 |
| Sodium hypophosphite | 0.04 | 0.04 | 0.04 |
| Heat stabilizer | 0.6 | 0.6 | 0.6 |
| Nigrosin batch | 0.5 | 0.5 | 0.5 |
| Carbon black | 0.1 | 0.1 | 0.1 |
| Lubricant | 0.2 | 0.2 | 0.2 |

TABLE 2
Mechanical properties (dry)

| | | | Compar- | Exam- | Exam- |
|---|---|---|---|---|---|
| | Unit | ISO | ison 1 | ple 1 | ple 2 |
| Tensile elastic modulus | MPa | 527 | 10804 | 10627 | 10688 |
| Breaking stress | MPa | 527 | 176 | 168 | 169 |
| Breaking elongation | % | 527 | 4.0 | 4.2 | 4.0 |
| Charpy impact | kJ/m² | 179-2/ | 102 | 101 | 103 |
| strength | | 1eU | | | |
| Charpy notched | kJ/m² | 179-2/ | 15.0 | 14.7 | 15.2 |
| impact strength | | 1eAf | | | |

TABLE 3
Storage in monoethylene glycol/water (1:1) at 120° C.

| | | | | | |
|---|---|---|---|---|---|
| Time [h] | Unit | ISO | Comparison 1 | Example 1 | Example 2 |

Tensile elastic modulus

| | | | | | | | | |
|---|---|---|---|---|---|---|---|---|
| 48 | MPa | 527 | 3848 | (100%) | 3665 | (100%) | 3819 | (100%) |
| 1000 | MPa | 527 | 4245 | (110%) | 4132 | (113%) | 4322 | (113%) |
| 2000 | MPa | 527 | 3991 | (103%) | 3764 | (103%) | 4138 | (108%) |
| 3000 | MPa | 527 | 3745 | (97%) | 3553 | (97%) | 3902 | (102%) |

Breaking stress

| | | | | | | | | |
|---|---|---|---|---|---|---|---|---|
| 48 | MPa | 527 | 93 | (100%) | 89 | (100%) | 91 | (100%) |
| 1000 | MPa | 527 | 74 | (80%) | 78 | (87%) | 79 | (86%) |
| 2000 | MPa | 527 | 38 | (41%) | 41 | (46%) | 50 | (55%) |
| 3000 | MPa | 527 | 17 | (18%) | 23 | (26%) | 31 | (34%) |

Breaking elongation

| | | | | | | | | |
|---|---|---|---|---|---|---|---|---|
| 48 | % | 527 | 8.7 | (100%) | 9.0 | (100%) | 8.7 | (100%) |
| 1000 | % | 527 | 4.4 | (51%) | 4.9 | (54%) | 4.7 | (54%) |
| 2000 | % | 527 | 1.3 | (15%) | 1.5 | (17%) | 2.0 | (23%) |
| 3000 | % | 527 | 0.6 | (7%) | 0.8 | (9%) | 1.1 | (13%) |

1. A thermoplastic molding material comprising
a) a mixture of 100 parts by weight of polyamide 6 or polyamide 6/6,6 and 7 to 50 parts by weight of aliphatic polyamide composed of C₄₋₁₀-diamine and C₈₋₁₆-dicarboxylic acid as component A),
b) 10 to 70% by weight, based on component A), of glass fibers as component B), and
c) 0 to 30% by weight, based on component A), of further additives as component C),
wherein the molding material comprises no thermoplastic polyamides distinct from polyamides of the component A).

2. The thermoplastic molding material according to claim 1 with a reduction in breaking stress according to ISO 527 after storage for 3000 h at 120° C. in a monoethylene glycol/water mixture in a 1:1 weight ratio of not more than 78%.

3. The thermoplastic molding material according to claim 1, wherein component C) comprises 0.05% to 3% by weight, based on component A), of carbon black.

4. The thermoplastic molding material according to claim 1, wherein component C) comprises 0.05% to 1% by weight, based on component A), of lubricants.

5. The thermoplastic molding material according to claim 1, wherein the aliphatic polyamide composed of C₄₋₁₀-diamine and C₈₋₁₆-dicarboxylic acid is polyamide-6,10, polyamide-6,12 or a mixture thereof.

6. The thermoplastic molding material according to claim 1, wherein component C) comprises 0.1% to 5% by weight, based on component A), of at least one heat stabilizer.

7. The thermoplastic molding material according to claim 1, wherein component C) comprises 0.05% to 1% by weight, based on component A), of nigrosin.

8. A process for producing a molding material according to claim 1, wherein the components A) and B) and optionally C) are mixed with one another.

9. A method of using the molding material according to claim 1, the method comprising using the molding material for producing fibers, films or shaped articles.

10. A fiber, film or shaped article made of a molding material according to claim 1.

11. A method of using mixtures of 100 parts by weight of polyamide 6 or polyamide 6/6,6 and 5 to 100 parts by weight of aliphatic polyamide composed of C₄₋₁₀-diamine and C₈₋₁₆-dicarboxylic acid in molding materials, the method comprising using the mixtures for producing shaped articles for increasing the hydrolysis resistance of the shaped articles towards water or aqueous liquids.

12. A method of using mixtures of 100 parts by weight of polyamide 6 or polyamide 6/6,6 and 5 to 100 parts by weight of aliphatic polyamide composed of C₄₋₁₀-diamine and C₈₋₁₆-dicarboxylic acid in molding materials, the method comprising using the mixtures for increasing the hydrolysis resistance of the molding materials towards water or aqueous liquids.

13. A method of using mixtures of 100 parts by weight of polyamide 6 or polyamide 6/6,6 and 5 to 100 parts by weight of aliphatic polyamide composed of C₄₋₁₀-diamine and C₈₋₁₆-dicarboxylic acid, the method comprising using the mixtures for increasing the breaking stress of shaped articles comprising such mixtures which are in contact with monoethylene glycol.

14. The thermoplastic molding material according to claim 1, wherein the aliphatic polyamide composed of C₄₋₁₀-diamine and C₈₋₁₆-dicarboxylic acid is polyamide-6,10.

15. The method of use according to claim 11, wherein the aqueous liquids are coolant mixtures.

16. The method of use according to claim 12, wherein the aqueous liquids are coolant mixtures.
